(19) United States
(12) Patent Application Publication
(10) Pub. No.: US 2017/0098342 A1
(43) Pub. Date: Apr. 6, 2017

(54) SYSTEM AND METHOD FOR ONLINE GAMING AND SHOPPING

(71) Applicant: MARKETISING SMART VENTURES LTD., Netanya (IL)

(72) Inventor: Binyamin ALON, Zofim (IL)

(21) Appl. No.: 14/872,234

(22) Filed: Oct. 1, 2015

(51) Int. Cl. G07F 17/32; G06Q 20/06; G06Q 30/02

(52) U.S. Cl. CPC G07F 17/3248; G07F 17/323; G06Q 30/0241; G06Q 20/0655

(57) ABSTRACT

A system and method may include providing a platform, the platform enabling an advertiser to advertise and sell a product, and the platform enabling a plurality of gamers to play interactive games and buy products from advertisers. A system and method may include allocating points to a gamer, and, upon determining that, using points, the gamer purchased a product from the advertiser, reducing a balance of the advertiser according to the number of points used by the gamer for purchasing the product. A playroom may be associated with an advertiser. A system and method may include enabling gamers to use points for purchasing goods from an advertiser if the amount of points in the pot of the advertiser is greater than zero.

### FIELD OF THE INVENTION

The present invention relates generally to social gaming. More specifically, the present invention relates to online gaming that includes winning points, the points usable for buying goods and services.

### BACKGROUND OF THE INVENTION

Online advertising is known in the art. For example, online advertising that includes banners presented in webpages is known. Online shopping is also known in the art. For example, websites such as Amazon® and eBay® enable users to shop online. Online gaming is known in the art. For example, web sites that enable user to play competitive or other games are well known.

However, using current systems and methods, an advertiser has no way of ascertaining that a sum of money spent on advertising a product is used for ongoing advertising of the product until sales resulting from the advertising cover the entire sum spent or cover a known portion of the sum spent.

### SUMMARY OF THE INVENTION

A system and method may include providing a platform, the platform enabling an advertiser to advertise and sell a product, and the platform enabling a plurality of gamers to play interactive games and buy products from advertisers. A system and method may include updating a balance of an advertiser based on a financial transaction received from the advertiser; allocating points to a gamer, and, upon determining that, using points, the gamer purchased a product from the advertiser, reducing the balance of the advertiser according to the number of points used by the gamer for purchasing the product. A system and method may include associating a playroom with the advertiser and setting a threshold for the playroom; enabling a gamer to participate in a game played in the virtual playroom if the amount of points in the pot of the gamer is higher than the threshold; and, if the gamer wins the game, transferring points from the global pot to the a pot of the gamer. A system and method may include enabling gamers to use points for purchasing goods from the advertiser if the amount of points in the pot of the advertiser is greater than zero.

A system and method may include associating a gamer with the advertiser and providing a gamer with a bonus by transferring points from a pot of the advertiser to a pot of the gamer.

Upon detecting a purchase of a product by a gamer, a system and method may transfer points from a pot of the advertiser to a pot of the gamer, wherein the amount of points transferred is calculated based on a discount provided by the advertiser. A system and method may add points to a pot of a gamer according to a financial transaction received from the gamer.

A system and method may, upon determining that a gamer used a coupon, transfer points from a pot of an advertiser to a pot of the gamer. A system and method may transfer bonus points from a global pot to a pot of a gamer. A system and method may transfer, according to a point threshold of a playroom, points from a plurality of gamers' pots to a global pot; determine a winner in a round of a game played in the playroom and transfer points from the global pot to a pot of the winner. A system and method may advertise a product in a playroom; and in response to a click of a gamer on an advertisement of a product, complete a sale of the product to the gamer. A system and method may include a live host presenter in a playroom by providing, in the playroom, a real-time live feed of video and audio of the host presenter.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows high level block diagram of an exemplary computing device according to some embodiments of the present invention;

FIG. 2 is an overview of a system according to some embodiments of the present invention;

FIG. 3 shows an exemplary flow according to some embodiments of the invention;

FIG. 4 shows an exemplary flow according to some embodiments of the invention;

FIG. 5 shows an exemplary flow according to some embodiments of the invention;

FIG. 6 shows an exemplary flow according to some embodiments of the invention; and

FIG. 7 shows an exemplary flow according to some embodiments of the invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although some embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

A system and method according to some embodiments of the invention may guarantee a return on investment (ROI) with respect to advertising. Generally, an embodiment of a system or method may receive a payment from an advertiser and may advertise a product or service until sales or profits generated by advertising the product or service cover the payment.

As described herein, some embodiments of a system and method according to the invention may enable users (also referred to herein as “garners”) to play social trivia game combined with an ability to win points and buy products for points and/or money in digital shops.

Some embodiments of a system and method according to the invention may enable suppliers or advertisers may invest funds (e.g., on a monthly basis) in return for advertisements, sponsored game rooms, leads and product sales. Users or gamers may be enabled to play an online game, earn points and can buy products for points and/or real money as well as buy points for real money.

The term product as referred to herein may be or may include a product such as a home appliance (e.g., an oven) or it may be or include a service, e.g., a network faxing or mail service or a subscription to a magazine. It will, therefore, be understood that some embodiments of the invention are not limited by the type of goods or services advertised and provided as described herein.

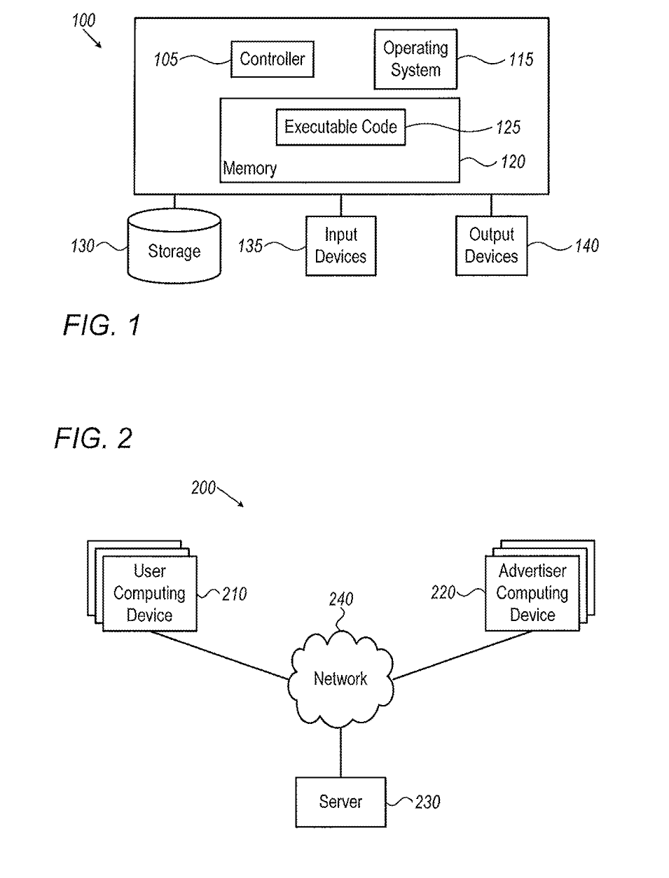

Reference is made to FIG. 1, showing a high level block diagram of an exemplary computing device according to some embodiments of the present invention. Computing device 100 may include a controller 105 that may be, for example, a central processing unit processor (CPU), a chip or any suitable computing or computational device, an operating system 115, a memory 120, an executable code 125, a storage 130, input devices 135 and output devices 140. Controller 105 may be configured to carry out methods described herein, and/or to execute or act as the various modules, units, etc. For example a system that updates a balance of an advertiser based on a payment from the advertiser, updates an amount of points in a global, or system points pot according to the financial transaction, transfers points from the system points pot to a points balance of an online gamer and reduces the balance of the advertiser based on purchases of products sold by the advertiser as described herein may be, or may include components of, computing device 100. A points pot may be referred to herein as a pot.

For example, by executing executable code 125 stored in memory 120, controller 105 may be configured to carry out a method of combined gaming, advertising shopping as described herein. For example, controller 105 may be configured to receive payment from an advertiser and keep advertising services or goods for the advertiser until sales (or profits from sales) of the advertised products, goods or services cover, or balance out, at least a predefined percentage of the payment. For example, to provide a complete ROI related to advertising a product, controller 105 may be configured to keep advertising a product until sales or profits from sales of the product are equal to a payment received by controller 105 from the advertiser.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that provides a complete ROI related to advertising a product as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. For example, units or modules described herein (e.g., user computing devices 210, advertiser computing devices 220 and server 230) may be, or may include, controller 105, memory 120 and executable code 125.

Storage 130 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content may be stored in storage 130 and may be loaded from storage 130 into memory 120 where it may be processed by controller 105. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays or monitors, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a printer, a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105.

Some embodiments may be provided in a computer program product that may include a non-transitory machine-readable medium, stored thereon instructions, which may be used to program a computer, controller, or other programmable devices, to perform methods as disclosed herein. Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 100.

Reference is made to FIG. 2, an overview of a system 200 according to some embodiments of the present invention. As shown, an embodiment of a system may include one or more user computing devices 210, one or more advertiser computing devices 220, a hardware server 230 and a network 240. User computing devices 210 may be any suitable computing device enabling a user or gamer to interact with a system as described herein. For example, one of user computing devices 210 may be a smartphone or a tablet computer, another may be a home computer and so on. In particular, user computing devices 210 may enable gamers to login in to server 230 or otherwise communicate over network 240. Network 240 may be any suitable network, e.g., the internet.

Advertiser computing devices 220 and server 230 may be a server computer or any other computing device as known in the art. In some embodiments, server 230 is a hardware server that includes components of computing device 100, e.g., a memory and a controller as described.

It will be understood that any number of user computing devices 210, advertiser computing devices 220 and servers 230 may be included in a system. For example, server computer 230 may be a system that includes two or more server computers. Server computer may be, or may include a web server as known in the art. For example, server computer 230 may include an Internet Information Services (IIS) as known in the art as well as an application for providing ROI to advertisers as described herein.

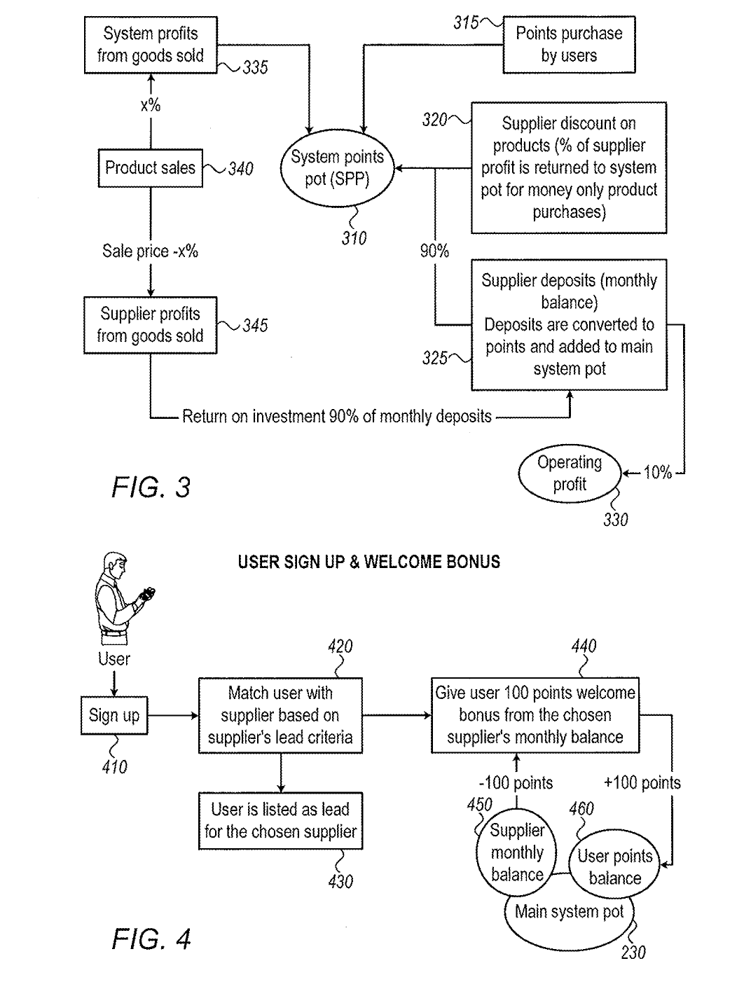

Reference is made to FIG. 3 which shows an exemplary flow according to some embodiments of the invention. As shown by the arrow connecting blocks 315 and 320, a system points pot (SPP) 310 may be updated based on points purchased by users. SPP 310 may be a variable stored in memory or in a file. For example, SPP may be a number or set of numbers in a file stored in storage 130 and/or in memory 120 of server 230. SPP may be, or include a set of variables or number that may be used to track and record transfers of points to and/or from SPP 310.

An embodiment of a system or method may include updating an amount of points in a global or system points pot according to the financial transaction. For example, PPS may be updated based on a purchase of points made by a user as shown by block 315. Purchasing of points as described herein may include a digital transaction as known in the art. For example, using a credit card number or other credentials, a gamer or an advertiser may transfer money to an account of an operator of server 230 and, based on the transaction, a variable or other object that stores the number of points of the gamer or advertiser may be updated. Similarly, SPP may be updated based on a purchase made by an advertiser or gamer. An account of an operator of server 230 or an operator or owner of a system according to some embodiments of the invention may be referred herein as a “system account”.

As shown by block 325, SPP 320 may be updated based on purchases made by suppliers or advertisers. For example, an advertiser may transfer a sum of money to a system account and SPP 230 may be updated to reflect the purchase. For example, if a point is defined to be worth $1 (one US dollar), then a transfer of $10 may cause a number stored in SPP 230 to be increased by 10. It will be understood that a value of a point in system 200 may be configurable and may thus be set to any number in any chosen currency.

Objects similar to SPP 230 may be maintained for users, gamers, advertisers or suppliers. For example, a variable, file or other construct or object that stores the number or balance of points of a gamer or advertiser may be maintained (e.g., in memory 120 and/or storage 130) and may be modified according to a purchase or spending of points by the gamer or advertiser as further described herein.

As shown by block 320, SPP 230 may be updated based on a percentage of revenues. For example, a predefined percentage or amount paid for a product may be returned to SPP 230 in the form of points. In some embodiments, a percentage or amount is returned to SPP 230 for purchases made using real money (not points). For example, if a gamer buys a product from a supplier (e.g., using online shopping as known in the art), a portion of the money paid for the product may be transferred to an account of the supplier and another portion may be converted to points that may be added to SPP 230.

Converting money to points may include calculating a number of points based on a sum of money based on a conversion rate or factor. For example, if a conversion rate or factor is $1=5 points, then converting $100 to points yields 500 points. Points resulting from a conversion as described herein may be added to a balance or pot. For example, updating SPP 230 as shown by blocks 315, 320 and 325 may include examining a transaction, determining the sum of money being transferred, calculating a number of points based on the sum and updating SPP 230 accordingly, e.g., increasing a number in SPP 230 by the calculated number of points.

As shown by block 330, a system profit may be generated. For example, upon receiving a transaction from a supplier (e.g., when the supplier buys points as described), 10% of the transaction may be directed to a system account, and the remaining 90% may be converted into points and stored in SPP 230 as shown.

As shown by blocks 335, 340 and 345, revenues resulting from product sales may be split between a seller or supplier and system 200. For example, when a gamer buys a product using points, 90% of the points used may be reduced from a balance of the supplier or advertiser, and 10% of the points used may be returned to SPP 230. Returning points to SPP 230 may include increasing a number in SPP 230 by the number of points returned.

ROI, as shown by the arrow connecting blocks 345 and 325, is further discussed below. Generally, an advertiser may purchase resources such as advertising space, virtual play rooms and leads by transferring money to a system account. Upon receiving a payment or financial transaction from an advertiser, seller or supplier, resources are established for the advertiser, seller or supplier as described herein. Upon receiving a payment or financial transaction from an advertiser, a points balance or pot of the advertiser may be updated, e.g., according to a conversion rate as described. A points balance or pot of an advertiser may be an object similar to SPP 230 as described herein. For example, upon receiving a payment of $100 from an advertiser, a points pot of the advertiser may be updated to include 500 points. For each sale of a product advertised for the advertiser by system 200, the points pot or balance of the advertiser may be decreased. For example, in the above example, assuming a conversion factor of 5 points per $1 and an ROI factor of 90%, if a product advertised for the advertiser is sold for $20, the points balance of the advertiser may be decreased according to the following equation: points to reduce from balance=($20*0.9)*5. In this example, if the advertiser paid $100 and the advertiser's points balance was 500 points prior to the sale, then after a sale of a product for $20 as described, the advertiser's points balance be updated according to: 500−90=410.

Advertising for an advertiser who purchased points as described may continue at least until the advertiser's points balance (or pot) reaches zero. For example, in the above example, advertising for the advertiser may continue and the advertiser's points balance may be reduced or decreased with each sale until 500 points are deducted from the advertiser's points balance. Accordingly, ROI related to advertising may be provided. For example, in the above example, the advertiser is guaranteed that the $100 spent on advertising buy him or her advertising resources for a predefined or known in advance revenue, sales or profits generated by an advertising campaign paid for.

Reference is made to FIG. 4 which shows an exemplary flow according to some embodiments of the invention. As shown by block 410, a user or gamer may signup or login to a system.

Signing up or logging into a system may include various steps and/or receiving information from the user. For example, a form may be presented to a user upon an initial signing into a system prompting the user to provide information or details such as a first and last name, an identification parameter (e.g., a social security number), a mobile phone number, an electronic mail (email) address, a birth date, a gender, marital status, a residential address, a username, a password and the like. A user may further be required to agree to terms & conditions, agree to receive promotional emails or other messages from the system, suppliers and/or advertisers. Agreement to terms and conditions may be done as known in the art, e.g., using a check box. An embodiment may only enable a user to create one and only one account (e.g., using an email as known in the art).

As shown by block 420, an embodiment of a system and method may present a list of products, advertisers or suppliers; prompt the user to select some products or suppliers that interest the user and associate the user with the selected products, advertisers or suppliers. For example, associating a user with a product or supplier may be done using a list or pointers as known in the art. For example, a database connected to server 230 may include a list of users, a list of suppliers or advertisers and pointes (or entries in the lists) may connect or link users in a user list with advertisers or suppliers in an advertisers list to achieve or cause an association of users with products, suppliers or advertisers. For example, upon signing or logging in, a user may be asked to select 10 product categories that interest the user and the selected categories may be associated with, or linked to, the user. An email provided by a user may be used to verify the user as known in the art (e.g., by sending a code to the email address and receiving the code, by server 230, from the user). As shown by block 430, based on a selection of the user, the user may be listed as a lead for the supplier. A lead as referred to herein may be as known in the art, e.g., a lead may be a potential buyer. For example, a name, telephone number or other contact information may be a lead. Listing a user as a lead may include associating the user with a supplier or product, for example, associating a user with a provider of a services or product may include linking (e.g., using a list or pointers as known in the art) the user with the provider such that a set of leads of or for a specific provider or supplier may be identified and/or provided, e.g., to the relevant provider or seller of goods or services. Using of leads is known in the art. For example, a supplier may be provided with leads and may communicate with the leads in order to offer goods or services.

Signing or logging into a system may be done via, or using a social network. For example, a user may sign or log into server 230 using his or her Facebook account. Using methods known in the art, user details may be pulled from Facebook, for example, a first and last name, an identification parameter (e.g., a social security number), a mobile phone number, an email address, a date of birth, a gender, marital status and a residential address may be obtained from a user's Facebook account as known in the art. Details not available from an account in a social network (e.g., a username and a password) may be provided as described herein. Information pulled from an account may be presented to the user for verification and/or modification. Accordingly, a user may logon to a system using direct login, e.g., by entering an address of server 230 in an address bar of a browser and providing a username and password. A user may alternatively use a Facebook or other account to logon to a system.

Logging into a system using an account of a social network (e.g., Facebook, Google+) is known in the art. In some embodiments, a user may be made to choose a logging procedure and may only be permitted to use the selected procedure. For example, if the user signed up to a system using his Facebook or Google+ account, then he may be permitted to log or sign in as shown by block 410 using only his account. If a user signed up using the regular or direct sign up (using a selected username and password as described), then she may only be permitted or enabled to log in by providing username and password chosen during sign up. For users who signed up using an account (e.g., a Facebook account), a an embodiment of a system and method may save a cookie on the user computing device, where the cookie serves as a flag that causes presenting a login using the account as known in the art.

An administrator may create accounts for advertisers or suppliers. For example, accounts for advertisers or suppliers may be created on server 230 as known in the art. A supplier may login, e.g., using a username and password, to a system via a designated “Supplier login” button in a webpage or using other methods known in the art. When logged in, a supplier may be provided with a content page, e.g., by server 230. A content page may include or show supplier news, important announcements and the like. A supplier may be provided with details related to his or her account, e.g., a points balance, sales of products and the like.

As shown by block 440, a user may be granted a welcome bonus (e.g., 100 points) upon an initial login or upon signing into system 200 for the first time.

For example, upon successful user account activation, the user may be granted 100 points from the balance of the supplier that was associated with the user, e.g., the supplier that was provided with the user as a lead. For example and described, the supplier chosen by the user as the one of interest may be the supplier that receives the lead. Associating a supplier with a user and/or granting the supplier with a lead may include presenting to the user at least one of: the supplier's name, supplier's name logo, supplier's name products available and supplier's name contact info. Granting a welcome bonus to a user may include sending a text message (e.g., a Short Message Service (SMS) message) that includes a 6 digit code which the user needs to enter at a prompt presented as known in the art.

As shown by the arrow connecting blocks 440 and 460, bonus points may be added to a user points balance or pot. A user point pot may be an object similar to SPP 320, but, unlike SPP 320, a user points balance or pot may include or reflect the points of a specific user. In some embodiments, a user points balance or pot is created and maintained for each user that signs into system 200. As shown by the arrow connecting blocks 450 and 440, a bonus given to a user may be deducted from a suppliers points balance or pot. A supplier's point pot may be an object similar to SPP 320 but, unlike SPP 320, a supplier's points balance or pot may include or reflect the points of a specific supplier. In some embodiments, a supplier's points balance or pot is created and maintained for each supplier that signs into system 200. For example, a supplier's or user's points balance or points pot is modified when the supplier or user buys or spends points, e.g., by increasing or decreasing a number that indicates the number of points in the balance or pot. As shown by the arrow connecting blocks 440 and 460, bonus points may be added to a user points balance or pot by decreasing 100 points in a supplier's pot and increasing by 100 the points in the user's pot. For example, points for a welcome bonus may be deducted from a points balance of the supplier chosen by the user as shown by block 420. Accordingly, a supplier may pay for leads using points.

An embodiment of a system and method may provide, support and present virtual playrooms (or simply playrooms). Generally, a playroom as referred to herein may be presented to a user or gamer in the form of a webpage that includes graphical information and objects that enable a user to play an online game as known in the art. A playroom may be operated by a web server (e.g., part of server 230 as described). Any information required in order to operate or support a playroom may be stored in server 230. A playroom may enable a number of users to play or compete in an online game, e.g., a trivia game as known in the art.

A number of playrooms may be supported, operated and presented to a user, e.g., upon logging in to a system. For example, an embodiment of a system or method may include one or more VIP playrooms where a high minimum wager or threshold is required in order to participate in a game, one or more regular playrooms where a medium or moderate wager or threshold is required in order to participate in a game, and one or more penny playrooms where a very low threshold is required in order to participate in a game. For example, based on a threshold of points in his or her points pot or balance, a user may be enabled to join a VIP, regular or penny playroom. For example, an embodiment of a system or method may include a limit or threshold of 10,000 points for joining a VIP playroom, and, accordingly, an embodiment of a system or method may let only users who have more than 10,000 in their balance to join a VIP playroom.

For example, regular rooms may enable users to play a game that includes simple trivia questions and designed for slow users. VIP rooms may include more advanced questions. An embodiment of a system or method may enable a new user to play in a regular playroom only, and if the user's success rate is high—the user may be upgraded to VIP playrooms. In some embodiments, a user can either play in regular playrooms or in VIP playrooms but not both. Penny playrooms may be available only to users with a 0 points balance and may require a very low threshold or wagering minimum, e.g., a threshold of 1 point. A minimum entrance threshold for each playroom may be configured by an administrator or operator for each supplier. When a playroom of a specific type (e.g., VIP or penny) and of (or associated with), a specific supplier is full, server 230 may create or open a new room of the same type for the supplier. Accordingly, a system and method according to embodiments of the invention may maintain a known or predefined number of playrooms, of a specific type, for each supplier.

Upon logging in, a lobby may be presented (e.g., in the form of a webpage). A lobby may include a list of playrooms available for a user, e.g., based on the points balance of the user and based on fields of interest (or products or suppliers of interest), a list of playrooms the user can enter may be presented.

In some embodiments, each playroom has 10 seats, and if there are open or free seats in a room, a user may be enabled to join the room and play. If all playroom seats are taken, a user may be given two options, either watch the game or be notified when seats in the playroom are available. If a user choses “let me know when room is available”, an embodiment of a system or method may prompt the user when seats are available, e.g., by sending a message (e.g., an email or SMS) wherein the message includes a link that, when clicked, carries the user to the playroom.

A playroom may include a presentation of at least one of: a room number, a name of the supplier sponsoring the room, a logo of supplier, icons of users currently in room and a threshold (e.g., a minimum number of points required) that a gamer must have in his pot in order to enter the playroom. For example, playrooms may be created for suppliers based on payment received from suppliers or advertisers, and, accordingly, a playroom created for a supplier or advertiser may include a presentation of the supplier's or advertiser's name, logo, products, contact information and the like.

In some embodiments, a user can join a playroom based only on one or more criteria related to the user and/or the playroom. For example, to join a specific playroom, the playroom's threshold must not be greater than 10% of the user's points balance and the user's points balance must further be 200 points or more.

In some embodiments, users with a points balance lower than a threshold may only be permitted to play in certain playroom categories or types. For example, users who have less than 200 points may only be permitted to play in playrooms where the wager or threshold is less than 10 points.

Permitting or enabling users to play in some playrooms and forbidding or disabling users to play in other playrooms may be done by presenting to users only the playrooms in which they can play. For example, a list of playrooms in a lobby as described may include only rooms in which the user is allowed to play based on rules, logic and criteria as described herein. Logic for selecting the rooms in which a user is permitted to play (e.g., based on playrooms thresholds, user's points balance etc.) may be performed by server 230, such that a webpage presented to a user shows the correct list of playrooms available for a user.

A playroom (or presentation of a playroom) may include, or include a presentation of, at least one of: logo of a supplier, a promoted product of the supplier, a question & answers display area, a user seats (e.g., each seat is shown as a user icon, first name, first letter of last name, number of rounds played etc.), a pot (e.g., an icon that includes the number of points in the pot), a player section with answer buttons usable for selecting an answer in a multiple choice quiz game), a timer, the player's point balance, the number of watchers in room, a “leave room button” button and a chat interface enabling chat between users.

An embodiment of a system or method may start a game in a playroom once there are players in playroom and/or last round has ended. An embodiment of a system or method may cause a 10 second (or other time period) delay between each round to allow new users to join the game. Once the game starts, an embodiment of a system or method may allow new users to join the playroom but may enable the new users to participate in the game only at the next round. Before each round, e.g., during the delay period between games, each user may be asked to approve joining the round and the wager points according to the playroom's setting, and if the user agrees (e.g., by pressing on a dedicated button), the wager may be deducted from the user's balance and transferred to the playroom's pot. A points balance or pot of playroom may be an object similar to SPP 230 as described herein.

In some embodiments, a game may be a multiple choice quiz game, and the first user who answers correctly may get the pot, and a next round may then begin. If no one answered correctly in a round, the round may be over, and pot points may be carried over to next the round. Questions in a quiz game may be “read” by a virtual host (e.g., by a text to speech (TTS) engine as known in the art or using a digital recording player). The correct answer may also be “read” out load by the virtual host. Sound effects may be used, e.g., to announce a start of a round, the correct answer, time laps and the like. Between rounds, an intermission may include displaying banners or video advertisements, e.g., advertisements related to the advertiser associated with the playroom as described.

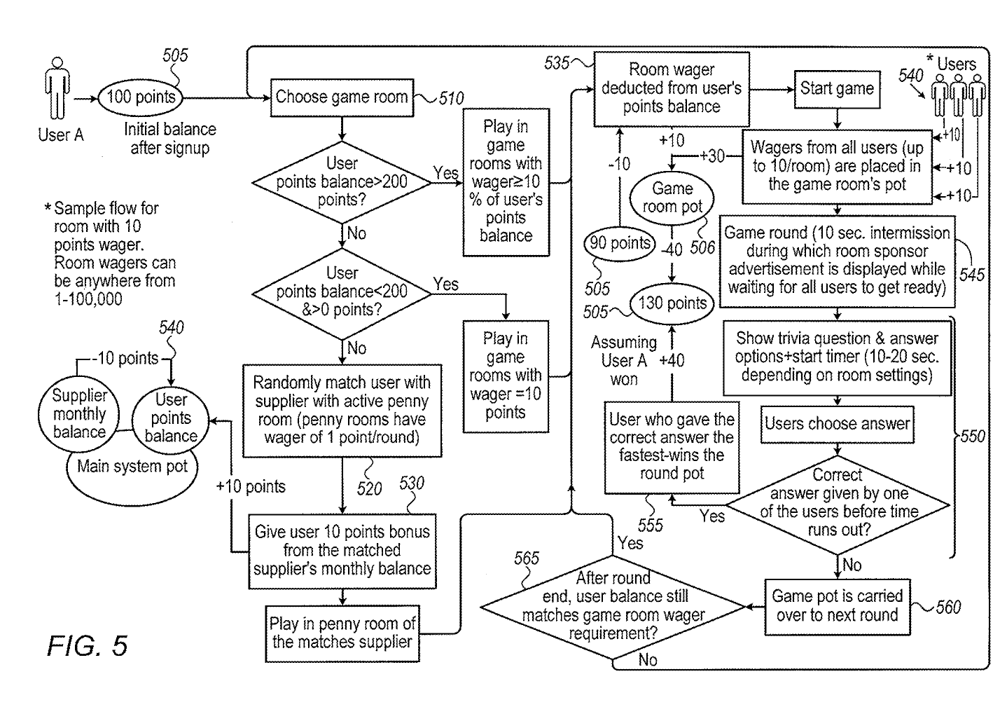

Reference is made to FIG. 5 which shows an exemplary flow according to some embodiments of the invention. As shown by block 510, following allocating a bonus upon initial signup, a choice of a playroom is made. For example, the bonus points may be added to user A's pot 505 as shown. As shown and described herein, playrooms may be chosen based on user's points pot or balance. For example, user “A” can play in VIP rooms if his or her points balance or points pot 505 is greater than 200 points, else the user “A” can play in regular playrooms. As shown by block 520, if user “A” has less than a predefined number of points (e.g., less than 200 points), the user may be associated with a supplier who is associated with a penny playroom. As shown by block 530, user “A” may be given a small amount of points (e.g., 10 as shown) and may then be enabled to play. As shown by arrow 540, the small amount of points may be deducted from the pot of the supplier who is associated with the user and the user may be enabled to play in the penny playroom associated with the supplier.

As shown by block 535, points from user points pot 505 may be deducted and further added to a playroom's pot. As shown, in an exemplary case, 10 points may be transferred from user's points pot 505 to playroom's points pot 506. As further shown, wagers from users 540 may also be added to playroom's points pot 506.

As shown by block 545, when waiting for wagers of all players (or users or gamers) to be transferred to the playroom pot, advertisements of a supplier may be presented to the players. As shown by blocks 550, a game may then begin, for example and as shown, a trivia game that includes presenting questions and receiving answers from players may begin. As shown by blocks 550, answers from players may be received (e.g., when users press one of four buttons to select an answer to a presented question) and the winner of the round may be the player who was the first to answer correctly. As shown by block 555, the round wagers may be transferred to the winners points pot. Accordingly and as shown, in the example shown in FIG. 5, user “A” may have wagered 10 points in order to participate in the game, and thus his points balance was decreased to 90 from the initial 100 points. In this example, after winning a round played by four players, user's “A” points balance is increased by 40 points (the round pot) and set to 130 points.

As shown by block 560, a game or round pot may be carried to the next round, e.g., if none of the players won the round. As shown by block 565, after a round ends balances or players may be checked and, if a player qualifies for playing in the current playroom (e.g., based on a threshold or criterion related to points as described) then he or she may be enabled to play another round in the current playroom, otherwise and as shown, the player may be enabled to choose a new playroom as shown by block 510 and described herein.

An embodiment of a system or method may include an online shop enabling users, players or gamers to shop online as known in the art. Online shopping, including presenting products for sale, receiving payment, arranging of shipment and the like are well known in the art and may all be supported by some embodiments of a system or method according the invention. An online shop may be included in some embodiments of a system or method according the invention, for example, a button that may carry a player to an online shop may be presented in any of the screens or webpages presented to a player, e.g., by server 230. In particular, an online shop may enable players to buy products using points won in a game played in a playroom as described herein. An online shop may enable players to buy products using real money or credit as known in the art. An online shop may enable players to buy products using credit and points, and, for example, a user or gamer may buy a product by paying or providing a first portion of the required amount using points, and paying or providing a second portion of the required amount using credit.

An online shop section may display and allow purchasing of active products of suppliers by registered users. Active products may be products sold by a supplier which are further marked or identified by an embodiment of a system or method as active. For example, a supplier may provide an embodiment of a system or method with a list of products (including images, prices and other information), and an embodiment of a system or method may mark some of the products as active and some or the products as inactive. For example, based on a points balance of a supplier, an embodiment of a system or method may mark products of the supplier as active or inactive. Marking a product as active or inactive may include associating the product with a status parameter (e.g., a variable in a memory) and setting the value of the associated status parameter to one of two values that indicate the status.

Products in an online shop may be available for view to unregistered users (e.g., users who did not sign up into a system as described) and a “Signup to buy” button instead of a “Buy” button may be presented to unregistered users. If an unregistered user tries to buy a product in the online shop, an embodiment of a system or method may prompt the user to sign up or login as described herein. An embodiment of a system or method may support or present a number of levels or categories of products. For example, a set of parent categories may be shown on a main shop page.

Clicking a parent category may cause an embodiment of a system or method to display a list of sub-categories and/or a list of recommended products associated with a parent category. As discussed, an embodiment of a system or method may only enable buying of active products. An embodiment of a system or method may show or present sold out products as well. An embodiment of a system or method may keep inactive products hidden, e.g., refrain from listing or showing the inactive products.

Products may be displayed in a gallery view as known in the art. Displaying products in an online shop may include displaying information such as: product image, product name, product description, product price, purchase method, e.g., money only/points only/money & points (hybrid), delivery time, supplier & supplier contact information, bonus points to be granted upon purchase, [buy] | or [notify when available] buttons with corresponding messages if minimum requirement to buy not reached or product is sold out etc.

An embodiment of a system or method may enable or disable a user to buy a product based only on a threshold, rule or criterion related to a game or to the number or balance of points of the user. For example, an embodiment of a system or method may enable a user to place orders (buy products) only if the user played at least 10 rounds in a game. For example, if a minimum number of rounds was not reached, a user, when clicking a Buy button in an online shop, attempting to buy a product, may be presented by an embodiment of a system or method with a popup message that reads “In order to buy products, you must play at least 10 rounds in game”.

A button that carries the user to a playroom may also be shown, and a click on the button may carry the user to a playroom associated with the product the user attempted to buy, and if no playroom is available, the user may be carried to a playroom based on his or her points balance as described, e.g., with reference to FIG. 5. When a user attempts to buy a product, e.g., when an embodiment of a system or method receives a click on a “Buy” button, an embodiment of a system or method may present as order summary including: a product name, product description, product cost (in point and/or money), shipment options, total to be billed and the like. In order to complete a purchase, a user may need to provide information such as name, address, billing information and the like.

An embodiment of a system or method may associate a product with bonus points. For example, a record or object that includes a product's details (e.g., stored on a storage 130 connected to server 230) may include a number of bonus points to be awarded upon purchase of the product. When a user buys a product, an embodiment of a system or method may credit the user's points balance with the number of bonus points indicated in the record or object of the product. Accordingly, a user may win or earn points by buying products. An embodiment of a system or method may enable purchasing a product using points. For example, an order for a product may be transferred to a supplier of the product and may deduct points from the buyers points balance. Points deducted from a buyers points balance may be transferred to a system pot and/or may be deducted from a balance of the supplier. An embodiment of a system or method may grant bonus points to a user upon buying a product and paying with real money (e.g., using a credit card as known in the art).

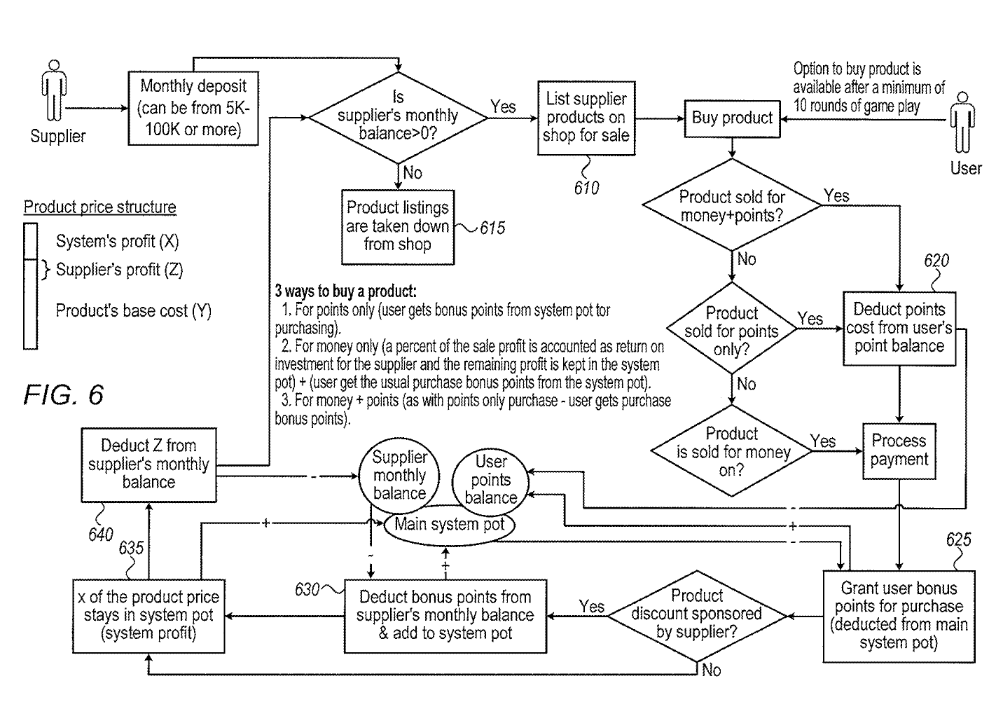

Reference is made to FIG. 6 which shows an exemplary flow according to some embodiments of the invention. As shown by block 610, if a supplier's balance is greater than zero then products of the supplier may be listed or presented in a digital shop. For example, a supplier may deposit money on a monthly basis or only once, an embodiment of a system or method may convert the money deposited by the supplier into points as described, the points balance may be checked as shown and, if the points balance is positive, an embodiment of a system or method may include products sold by the supplier in a digital shop as described. As shown by block 615, if the points balance of the supplier is less than (or equal to) zero, products of the supplier may be removed from a digital shop. As shown by block 620, when a user purchases a product using points, points are deducted from the user's balance as described herein. As shown by block 625, bonus points may be granted to a user who bought a product, for example, and a points balance of the user may be increased to reflect a bonus. As shown by block 630, a discount provided by a supplier may be deducted from the supplier's points balance and added to a system points pot. As shown by block 635, a portion of the points used for buying the product may be returned to the system points pot. As shown by block 640, a sum of points may be deducted from the suppliers points balance. Accordingly, the balance of the supplier is reduced based on, or as a function of, sales of products being advertised or promoted by an embodiment of a system or method.

An embodiment of a system or method may create and present a recommended product list, e.g., for products that are slow to sell. An embodiment of a system or method may allocate advertising space to a supplier based on the suppliers points balance or based on a monthly deposit made by the supplier. For example, if the general system points pot has 100,000 dollars in points in it, where the system points pot includes, in points, deposits made by all suppliers, then a supplier that has deposited 10,000 points in the system points pot may receive 10% of the available advertising space in a website operated by an embodiment of a system or method.

A user may invite other users to sign up to a system. An embodiment of a system or method may present an “Invite friend” button in a webpage, and, when the button is clicked, an embodiment of a system or method may prompt the user to provide a name and an email address (or other contact information). Provided with a name and address, an embodiment of a system or method may send an invitation to the friend. An embodiment of a system or method may enable a user to send or give points to another user. For example, a “redeem” button or form in a webpage may enable a user to provide a name of another user and a number of points to be given and an embodiment of a system or method may transfer points from the user's points balance to the other (receiving) user's points balance. Transferring points from one balance or pot may include deducing points from a first balance or pot and adding the reduced points to another points balance or pot as described. In order to transfer points, a user may be required, by an embodiment of a system or method, to meet a criterion, e.g., the user must play at least 10 rounds in a game before the option to transfer points is enabled or becomes available. Clicking on a “Transfer points” button may open a popup allowing the user to see his current points balance and enter the amount of points he wishes to send to another user. Points may be transferred to any user logged on the system. Upon points transfer, the user who got the points may get a message (e.g., in an inbox as known in the art) announcing the transfer. A user inbox supported by server 230 may be as known in the art, e.g., including functionality and information such as: Send new message, view received message, view list of messages received, new message indication, sender's information (e.g., name, icon, etc.).

User profiles may be supported. For example, an embodiment of a system or method may maintain, e.g., in a database operatively connected to server 230, user profiles in files or other suitable constructs. A user profile may include information such as name, icon to be used for showing the users to other users (e.g., in a playroom) and the like. An embodiment of a system or method may enable users to chat. For example, a chat as known in the art may be supported from within a webpage as known in the art.

A user may be enabled to invite another user to play by clicking an “Invite to play” button that may be placed near, under or on an icon of another user. For example, a webpage may show all or some users currently logged in and a user can select to invite other users to play in a selected playroom. In some embodiments, after clicking invite to play, a user will be shown a list of playrooms that both the inviting and the invitee can play based on the wager of the room and the points balance of each user. By clicking on a room from a list, the invited user will receive a message pointing him or her to the playroom.

A system and method according to some embodiments of the invention may support, enable or perform various operations. For example, operations, methods or procedures related to aspects such as, but not limited to: ordering & payment, post ordering actions, advertising slots, presenting recommended products, managing advertising quotas and welcome bonuses, managing user areas, profiles or accounts, transferring points from one user to another, transferring points from a user or supplier to a system pot, transferring points from a supplier to a user, sending messages, enabling a user to invite another user to play, managing orders, managing and tracking delivery of products, managing coupons, managing suppliers area, managing products (e.g., operations such as add, remove, edit and shipment of products) and other administrative tasks” may be facilitated, supported, enabled or performed by server 230 that may include a web server and other applications as known in the art.

For example, upon clicking a “Buy” button presented to a user with a presentation of a product, an ordering process may be performed by server 230. Server 230 may present an order summary including: product name, product description, product cost (point and/or money), shipment options (user must pick one), total to be billed and the like. To make the purchase, user may be required to provide information such as: first name, last name, company name, address, city, country, phone, email, etc.

Billing information may be prefilled, by server 230, with the data the user provided at signup with an option to edit the information before submitting the order. Server 230 may request (e.g., using a form as known in the art) shipping information, e.g., Ship to: Name, Address, City, Country (Israel only), Comments. Server 230 may request Credit card or PayPal account information as known in the art, e.g., card number, expiry date, etc. Server 230 may redirected a user to the PayPal or other site for completion of payment as known in the art.

Upon purchasing products that have bonus points to award upon purchase, server 230 may credit the user's points balance with the set amount of bonus points. The user may be notified about the bonus in his Inbox as well as presented with a popup ‘You got bonus points’ upon successful order payment. For products sold for points only, the usual ordering process as described herein may apply, with the exception that the user may only need to pay for shipment. Upon ordering, the cost in points may be deducted, by server 230, from the user's account or points pot.

Bonus points may be awarded for a purchase made with money only (not using points as described herein) based on a setting or configuration of the product. For example, an administrator may configure a product such that even if the product is bought using real money and no points, bonus points are still awarded to the buyer. When using points to purchase a product, the amount of points that will be deducted from a user's points pot may be shown to a user, e.g., with the presentation of the product or upon an actual purchase of the product.

Products may be purchased using coupons as known in the art. Bonus points may be awarded for any purchase, including a purchase made using coupons. Coupons may be redeemed, e.g., via the User area as described herein.

Upon successful, or completion of an order, server 230 may send an email to a user, the email may include order details for follow up. The order details may also be available on User's area, e.g., under an “Orders” section. When the delivery date of a product has arrived, server 230 may send an email to a user requesting the user to confirm that the product has arrived and/or prompting the user to report any issues related to the product, delivery and the like.

Server 230 may display (e.g., in a webpage as known in the art) products that are slow to sell in a “recommended products” box, page or list. For example, a “recommended products” box, page or list may show the 20 slowest to sell products.

As described, money deposited by suppliers to the system may be converted to points and the points may be added to the system's points pot. Welcome bonuses and point bonuses may be deducted from the system's points pot. Each supplier may be advertised, e.g., on webpages presented to users by server 230, until the supplier reaches 100% ROI by selling products.

The advertising space (e.g., on webpages as known in the art) and views may be divided among the suppliers based on their respective payments or account size. For example, if the system's points pot has 100,000 dollars in it (system's points pot=sum of all deposits made by suppliers), then a supplier that has deposited $10,000 will receive 10% of the available advertising impressions on a website maintained by server 230. For example, advertising space (or real estate as known in the art) on a website site may be used to show banners of all suppliers with rotation and exposure proportional to the suppliers' respective deposits or account size. A playroom associated with a specific supplier may only include advertisements of the supplier associated with the playroom.

Server 230 may enable a user to invite a friend to play. For example, server 230 may present, in a webpage, an “invite friend” button usable for inviting a friend. Upon pressing an invite button, a user may be prompted to provide an email or other contact information and, using information provided, server 230 may send an invitation to the friend. Server 230 may enable a user to give points to a friend. For example, a “Give your friend a 100 points as a gift”. button may be presented and, when pressed, server 230 may send an invitation to the friend, and include in the invitation a button that, when pressed, carries the friend or invitee to a webpage where the invitee can join a playroom and be given the gift points (that may be transferred from the inviters points pot to the invitee's points pot). In some embodiments, server 230 may present a list or icons of friends (e.g., friends in Facebook) and may further show the friends' status (e.g., online). Server 230 may present, near each friend, a button usable to “send points” and/or “chat”. Clicking on a friend's icon may open or show the friend's profile or other information related to the friend.

Server 230 may maintain user profiles. For example, a user profile may include information such as: first name, first letter of last name, user avatar (or icon), number of points in user's points pot, game statistics (e.g., number of rounds played, room last played, most frequently played room, last win amount etc.). A user may be enabled to edit some of the information in a profile, e.g., change user name and the like.

Using webpages, forms and other methods known in the art, server 230 may enable to follow orders, delivery status and the like. For example, server 230 may present, to a user, information related to: an order, a history of an order, delivery of an order and the like. For example, information such as: date of ordering, delivery by date, product name, purchasing price (money and/or points), delivery address, payment option used, supplier & supplier info may be presented.

Server 230 may receive, from users a message with any issues regarding an order delivery. For example, upon clicking a “Report issue with delivery” button presented in a webpage, a user will be asked to enter message text and click send. A reply from a site administrator may be received as a personal message in an inbox of the user, a reply may include a link to the order in question.

Server 230 may present, e.g., in a section in a user area, a button enabling the user to redeem a coupon code in exchange for points. User may enter a coupon code and server 230 may credit the user's account with the amount of points the coupon is worth. In some embodiments, a coupon can only be used once per user.

Server 230 may maintain a supplier are or section for each supplier. A supplier area or section may include one or more webpages presented to a supplier based on data in one or more files (e.g. on storage 130). Each supplier may have (and be presented with) his or her own supplier area or section (e.g., based on data in files associated with the supplier). A supplier area or section may include, present and enable to modify information such as: first name, last name, phone, email address, year of birth, sex, city, marital status and bonus points awarded. A supplier area or section may present a list of leads associated with the supplier (users associated with the supplier as described).

Server 230 may enable suppliers to manage products. For example, a supplier may be presented with, and where applicable, enabled to modify, information such as: product categories, product image, product name, product description, product selling price, number of credit card payments, bonus points awarded upon purchase, profit margin, units sold this month, units sold last month, status (e.g., active, no balance, sold out), pending approval of administrator (e.g., if product was edited by supplier and is awaiting admin approval). It will be understood that the examples above are only some of the information presented or modified by a supplier, and that any other information related to products, sales or other relevant aspects may be presented or edited by a supplier in a supplier area or section.

A supplier may upload products to server 230 by providing information such as; product name, product description, product image, selling price, bonus points to award upon purchase, etc. Any system or method for uploading data to a server as known in the art may be used by a supplier in order to upload products to a web server, e.g., server 230. Any system or method for managing sales as known in the art may be used.

For example, server 230 may enable a supplier to set shipment options (e.g., self-pickup, express delivery within 48 hours, regular delivery within X days etc.). For each shipment method, a supplier may set a shipment fee that may be added to the total purchase price. Users may choose one of the available shipping methods. A public supplier profile may include the supplier's name and logo, contact information, playrooms associated with the supplier and so on.

A supplier may issue a series of coupon codes for a promotion. A coupon may include, be associated with, and/or be identified by, a promotion ID, name and end date, a coupon type (e.g., series or single), a code prefix, number of similar coupons issued and the like. Server 230 may generate, for each promotion, a list of the coupon codes using the same prefix (e.g., APR00001).

Coupon code of type “series” may be unique, e.g., never used twice for different series of coupons. Coupon code of type “single” may be used once by each user and may further be reused by other users as long as the promotion hasn't expired. Value of coupons issued by a supplier may be deducted from the supplier's account, balance or points pot. For example, the saving (or discount) provided by a coupon may be converted into points and the resulting amount of points may be deducted from the supplier's points pot.

A profit margin for a supplier may be set by an administrator, e.g., a 25% profit margin. A profit margin for each supplier may be set individually and may vary from one supplier to another. A profit margin may be used to calculate an ROI. For example, upon selling a product, a profit margin value or parameter (e.g., 25%) may be used to calculate the amount to be deducted from the amount invested by the supplier (e.g., the amount received from the supplier and converted into points as described herein) to determine a balance. Once the balance of a supplier reaches zero, server 230 may disable advertising the supplier, terminate association of the supplier with playrooms or other stop services for the supplier. Accordingly, a supplier is guaranteed to receive exposure and advertising of a product until predefined, known in advance, sales of the product were made or predefined, known in advance revenues related to the product were received.

An administrator may add, remove or edit product categories, e.g., set a category to active or inactive, change a name of the category, add or remove products to/from a category and the like. An administrator may create a supplier's account by creating a new account and providing information such as: first and last name of contact person, company name, email, phone, fax, address, monthly budget (account size), number of products the supplier can add to the shop from his area and the like.

Upon entering the monthly budget, server 230 may display the account's advertising allotment that may be calculated automatically and presented, for example, an allotment may include account size (e.g., as a percentage of all budgets of active supplier accounts in a system, and number of lead percentage available per month

Generally, server 230 may treat a new user sign up as a lead. Server 230 may associate a lead with a supplier based on parameters such as: age, marital status, geographical data (e.g., address, work place etc.), products the user is interested in, etc. Server 230 may associate a supplier with leads based on the size of the supplier's account, balance or points pot.

The number of advertising views may be controlled by server 230; however, an administrator may enable or disable advertisements for a specific supplier, in some or all sections of a website (e.g., in some playrooms). For example, an administrator may enable or disable advertisements in, or of, one or more of: a home page banner, a game banner, a game intermission banner, a banner in a shop, a side banner, etc.

Server 230 may present (e.g., to an administrator) a list of suppliers and related information, including, for each supplier, information such as: account status, first name, last name, company name, account size, monthly quota (e.g., how much this supplier needs to deposit each month), account size (e.g., percentage of all active accounts), account balance, profit margin, number of sold products, revenues, advertisements impressions, number of users who saw advertisements, number of users who purchased products from the supplier, number of associated leads etc.

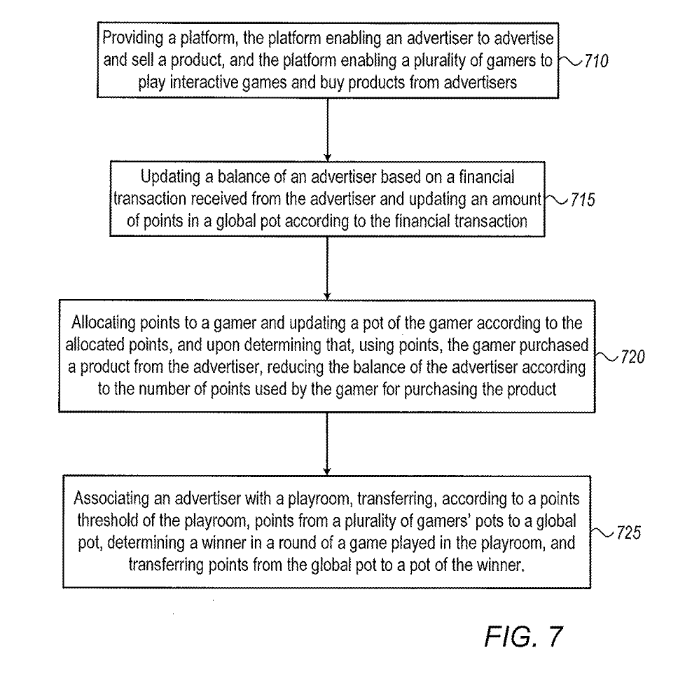

Reference is made to FIG. 7 which shows an exemplary flow according to some embodiments of the invention. As shown by block 710, a platform enabling an advertiser to advertise and sell a product, and enabling a plurality of gamers to play interactive games and buy products from advertisers may be provided. For example, using webpages and other known methods, server 230 may provide a platform that includes playrooms, electronic shops and maintain pots as described herein.

As shown by block 715, a balance of an advertiser and an amount of points in a global pot may be updated based on a financial transaction received from the advertiser. For example, server 230 may receive a payment from an advertiser and update the balance of the advertiser and the amount of points in a global (or system) pot according to the payment. As further described, a system and method may advertise an advertiser until the balance of the advertiser is zero. For example, according to some embodiments of the invention, each time a product or service advertised by a system is purchased, a balance (e.g., number of points in a pot) of the advertiser is decreased by a calculated amount (e.g., by a percentage of the price of the purchased product).

Accordingly, an ROI related to advertising by a system and method according to some embodiments of the invention may be guaranteed. For example, a system and method according to some embodiments of the invention may enable gamers to use points for purchasing goods from the advertiser if the amount of points in the pot of the advertiser is greater than zero. Accordingly, advertising products of an advertiser may continue as long as there are points in the pot of the advertiser. Using some embodiments of the invention, an advertiser can determine or set the amount of exposure he or she gets based on the number of products sold. For example, assuming 10 points are reduced for each sale of a product and, at some point in time, the advertiser has 100 points in his or her pot, then a system and method according to some embodiments of the invention may continue advertising products for the advertiser until 10 more products are sold.

As shown by block 720, points may be allocated to a gamer. For example, points may be added to a pot of the gamer according to a financial transaction received from the gamer. Other methods according to some embodiments of the invention may be used to enable gamers to buy points, e.g., methods as known in the art. As shown by block 720, a gamer's pot may be updated to reflect a purchase or allocation of points. For example, upon purchasing points or winning a game, the number of points in a gamer's pot may be increased.

In other cases, allocating points to a gamer may include providing a bonus, e.g., by transferring bonus points from a global pot to a pot of a gamer. For example, a system and method according to some embodiments of the invention may provide a bonus to gamers upon signing into a system for the first time, upon purchasing a product and so on. For example, a system and method according to some embodiments of the invention may associate a gamer with an advertiser and provide the gamer with bonus points by transferring points from a pot of the advertiser to a pot of the gamer. For example, as described, based on demographic information (e.g., age, gender, address and the like), fields of interest, preferred games or other information provided by a gamer (e.g., upon logging in), the gamer may be associated with a selected advertiser and may be carried to a playroom of, or associated with, the selected advertiser. For example, gamers aged 10 to 14 may be associated with an advertiser who sells games and gamers aged 30 to 70 may be associated with an advertiser who sells insurance policies. Accordingly, points of an advertiser may be used, or exchanged, for providing the advertiser with leads (potential buyers).

As shown by block 720, upon determining that, using points, a gamer purchased a product from an advertiser, a system and method according to some embodiments of the invention may reduce the balance of the advertiser according to the number of points used by the gamer for purchasing the product. For example, according to some embodiments of the invention, upon purchasing a product by a gamer, points from a pot of the advertiser may be transferred to a pot of the gamer. For example, the amount of points transferred may be calculated based on a discount provided by the advertiser. Accordingly, a system and method according to some embodiments of the invention may enable an advertiser to provide a discount for a product in the form of points returned to a purchaser of the product. In some embodiments, upon determining a gamer used a coupon to purchase a product from an advertiser, points from a pot of the advertiser may be transferred to a pot of the gamer. Accordingly, a system and method according to some embodiments of the invention may enable an advertiser to issue coupons that are only used when an actual purchase is made and are further used to only manipulate points, e.g., transfer points from a pot of the advertiser to a pot of the gamer without applying a discount.

As shown by block 725, an advertiser may be associated with a playroom. For example, one or more playrooms may be created and presented by server 230 for a specific advertiser. A playroom of (or associated with) an advertiser may be dedicated to advertising products and services sold by the advertiser. For example, only products and services sold by a specific advertiser may be advertised in a playroom associated with the advertiser. Gamers may enter a playroom (e.g., by selecting the playroom from a list) and play a game in the playroom. According to some embodiments of the invention, points according to a threshold of the playroom may be transferred from a plurality of gamers' pots to a global pot. For example, before each round of a game played in a playroom, a system and method according to some embodiments of the invention may transfer an amount of points from the pots of each of the gamers participating in the next round to a system or global pot. As described, a system and method according to some embodiments of the invention may apply a points threshold to a playroom, and only enable gamers who have enough points in their pots (e.g., the number of points in a gamer's pot is higher than a threshold associated with the playroom) to enter the playroom, or play in the playroom.

As shown by block 725, a system and method according to some embodiments of the invention may determine a winner in a round of a game played in the playroom, and may transfer points from the global pot to a pot of the winner. For example, the points transferred from all participants in a round before the round starts may be transferred to the pot of the winner in the round.

A system and method according to some embodiments of the invention may include a live host presenter in a playroom. For example, a real-time or live feed of video and audio of a human presenter may be presented in a playroom. The presenter may read out announcements related to the game (e.g., a countdown), announce a winner and so on. The presenter may announce any event, e.g., promote or advertise goods, a special sale or price offering and so on.

In some embodiments, a playroom (or virtual playroom) may be shown, displayed or presented in three dimensions (3D), e.g., as known in the art. For example, players may be shown, in 3D, as standing behind a counter or podium. In some embodiments, a stage may be shown, in 3D. In some embodiments, advertisements may be shown in 3D. In some embodiments, a live presenter may be shown in 3D.

In some embodiments, an operator of a system may finance points in the global or system pots. For example, instead of adding points to SPP 310 based on charging a supplier as shown by the arrows connecting blocks 320 and 325 with block 310 in FIG. 3, an operator of system 200 may himself finance the points in SPP 310. Accordingly, a supplier or advertiser may only pay for virtual playrooms and/or other advertising assets while bonuses and other payments (e.g., made using points as described) may be financed by an operator of a system according to embodiments of the invention.

Unless explicitly stated, the method embodiments described herein are not constrained to a particular order in time or chronological sequence. Additionally, some of the described method elements may be skipped, or they may be repeated, during a sequence of operations of a method. While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method of social online gaming, the method comprising:
providing a platform, the platform enabling an advertiser to advertise and sell a product, and the platform enabling a plurality of gamers to play interactive games and buy products from advertisers;
updating a balance of an advertiser based on a financial transaction received from the advertiser;
updating an amount of points in a global pot according to the financial transaction;
allocating points to a gamer and updating a pot of the gamer according to the allocated points; and
upon determining that, using points, the gamer purchased a product from the advertiser, reducing the balance of the advertiser according to the number of points used by the gamer for purchasing the product.

2. The method of claim 1, the method further comprising:
associating a gamer with the advertiser; and
providing the gamer with a bonus by transferring points from a pot of the advertiser to a pot of the gamer.

3. The method of claim 1, further comprising, upon purchasing a product by a gamer, transferring points from a pot of the advertiser to a pot of the gamer, wherein the amount of points transferred is calculated based on a discount provided by the advertiser.

4. The method of claim 1, further comprising, adding points to a pot of the gamer according to a financial transaction received from the gamer.

5. The method of claim 1, further comprising, upon determining a gamer used a coupon, transferring points from a pot of the advertiser to a pot of the gamer.

6. The method of claim 1, further comprising, transferring bonus points from the global pot to a pot of a gamer.

7. The method of claim 1, further comprising:
transferring, according to a points threshold of a playroom, points from a plurality of gamers' pots to a global pot;
determining a winner in a round of a game, the game played in the playroom; and
transferring points from the global pot to a pot of the winner.

8. The method of claim 1, further comprising:
associating a playroom with the advertiser and setting a threshold for the playroom;
enabling a gamer to participate in a game played in the virtual playroom if the amount of points in the pot of the gamer is higher than the threshold; and
if the gamer wins the game, then transferring points from the global pot to the a pot of the gamer, and
if the gamer does not win the game, then transferring points from the pot of the gamer to a global pot.

9. The method of claim 1, further comprising enabling gamers to use points for purchasing goods from the advertiser if the amount of points in the pot of the advertiser is greater than zero.

10. The method of claim 1, further comprising:
advertising a product in a playroom; and
in response to a click, of a gamer, on an advertisement of a product, completing a sale of the product to the gamer.

11. The method of claim 1, further comprising:
including a live host presenter in a playroom by providing, in the playroom, a real-time live feed of video and audio of the host presenter.

12. A hardware server configured to:
provide a platform, the platform enabling an advertiser to advertise and sell a product, and the platform enabling a plurality of gamers to play interactive games and buy products from advertisers;
update a balance of an advertiser based on a financial transaction received from the advertiser;
update an amount of points in a global pot according to the financial transaction;
allocate points to a gamer and updating a pot of the gamer according to the allocated points; and
upon determining that, using points, the gamer purchased a product from the advertiser, reduce the balance of the advertiser according to the number of points used by the gamer for purchasing the product.

13. The hardware server of claim 12 configured to:
associate a gamer with the advertiser; and
provide the gamer with a bonus by transferring points from a pot of the advertiser to a pot of the gamer.

14. The hardware server of claim 12 further configured to:
upon purchasing a product by a gamer, transfer points from a pot of the advertiser to a pot of the gamer, wherein the amount of points transferred is calculated based on a discount provided by the advertiser.

15. The hardware server of claim 12 further configured to, upon determining a gamer used a coupon, transfer points from a pot of the advertiser to a pot of the gamer.

16. The hardware server of claim 12 further configured to transfer bonus points from the global pot to a pot of a gamer.

17. The hardware server of claim 12 further configured to:
transfer, according to a points threshold of a playroom, points from a plurality of gamers' pots to a global pot;
determine a winner in a round of a game played in the playroom; and
transfer points from the global pot to a pot of the winner.

18. The hardware server of claim 12 further configured to:
associate a playroom with the advertiser and setting a threshold for the playroom;
enable a gamer to participate in a game played in the virtual playroom if the amount of points in the pot of the gamer is higher than the threshold; and
if the gamer wins the game, then transferring points from the global pot to the a pot of the gamer, and
if the gamer does not win the game, then transferring points from the pot of the gamer to a global pot.

19. The hardware server of claim 12 configured to only enable gamers to use points for purchasing goods from an advertiser if the amount of points in the pot of the advertiser is greater than zero.

20. The hardware server of claim 12 further configured to include a live host presenter in a playroom by providing, in the playroom, a real-time live feed of video and audio of the host presenter.
